(19) United States
(12) Patent Application Publication
(10) Pub. No.: US 2026/0164531 A1
(43) Pub. Date: Jun. 11, 2026

(54) Plasma Source for High-Repetition-Rate Accelerators

(71) Applicants: ISTITUTO NAZIONALE DI FISICA NUCLEARE, Roma (IT); UNIVERSITA' DEGLI STUDI DI ROMA "LA SAPIENZA", Roma (IT)

(72) Inventors: Angelo Biagioni, Roma (IT); Lucio Crincoli, Roma (IT); Riccardo Pompili, Roma (IT); Romain Demitra, Roma (IT); Enrica Chiadroni, Roma (IT); Valerio Lollo, Roma (IT); Donato Pellegrini, Roma (IT); Massimo Ferrario, Roma (IT)

(21) Appl. No.: 19/408,929

(22) Filed: Dec. 4, 2025

(30) Foreign Application Priority Data
Dec. 6, 2024 (IT) 102024000027750

(51) Int. Cl. H05H 1/54; H05H 1/02; H05H 7/08

(52) U.S. Cl. CPC H05H 1/54; H05H 1/02; H05H 7/08

(57) ABSTRACT

A plasma source for high-repetition-rate accelerators includes: a plasma-confining structure made of a first ceramic material and configured to develop along a longitudinal direction according to a tubular geometry, including a plasma formation channel, a service channel substantially parallel to the plasma formation channel, a plurality of injectors adapted to provide a fluidic connection between the plasma formation channel and the service channel; a support structure made of a second ceramic material and configured to house the plasma-confining structure.

### CROSS-REFERENCE TO RELATED APPLICATIONS

This application claims priority to Italian Application No. 102024000027750, filed Dec. 6, 2024, which is incorporated herein by specific reference in its entirety.

### DESCRIPTION

### Field of the Invention

The present invention relates to the field of accelerators based on plasma technology. More specifically, the present invention relates to a plasma source for high-repetition-rate accelerators capable of reaching accelerating gradients on the order of tens of GV/m.

### Technical Problem to Be Solved

In the field of particle accelerators based on plasma technology, a key point is the design of the plasma confining and formation structures, hereafter referred to as plasma sources. Plasma creation occurs through application of high-voltage discharges, characterized by voltages on the order of tens of kilo Volts and currents on the order of hundreds of Amperes, across the ends of gas columns confined in thin channels having diameters on the order of a few millimetres and lengths of several tens of centimetres.

Such channels are called plasma-formation channels, or plasma-confining channels. As will be further described below, a plasma source comprises additional elements, such as auxiliary channels, or injectors, through which a neutral gas is supplied into a plasma-confining channel to be transformed into plasma during an ionization phase.

The main problem to be faced when designing this type of confinement structures, also known as plasma sources for accelerators, is the lifetime of a plasma source before it suffers a degradation of its characteristics, since lifetime directly affects the number and duration of the experiments that can be carried out. For this reason, the geometries and materials employed for creating a plasma source are still a problem that needs to be solved when such sources are intended for use in high-repetition-rate accelerators. The lifetime of a plasma source can be increased by selecting a proper geometry, i.e. suitable shapes and/or dimensions, for the plasma-confining channel and the injectors, and by choosing materials capable of withstanding the high temperatures that can be reached during the electric-arc formation process.

This is due to operating conditions in which, during a plasma formation process, the temperatures in the plasma formation channel can reach an order of magnitude of several tens of thousands of Celsius degrees.

This problem is particularly limiting when plasmas are used in latest-generation accelerators, wherein the repetition rate for plasma creation in said structures must be at least 100 Hz and may reach or even exceed 1,000 Hz. Of course, this problem is directly proportional to the repetition rate, and some materials, like glass, begin to show signs of deterioration at rates as low as 10 Hz. Therefore, greater strength leads to a longer lifetime, and hence to a lower frequency of replacement of deteriorated parts inside the particle accelerator during the experiments, which directly translates into lower costs.

The use of plasma technology in particle accelerators is thus dependent on the possibility of obtaining plasma sources made of materials that can resist the thermal stresses produced during the formation of plasmas for accelerators. Here, resistance to thermal stresses refers to the ability to suffer no structural modification because of the high temperatures reached when such plasma sources are used for confining plasmas produced with energy in the range of 2 to 10 eV. Resistance to thermal stresses is an important factor, because higher resistance results in a longer lifetime of the plasma source.

Lifetime is expressed as the total number of high-voltage discharges, generated at a repetition rate of 100 Hz, that a plasma source can withstand before such discharges start to modify the physical characteristics of the source itself. In particular, the lifetime of a plasma source represents one of the crucial aspects that researchers have to take into account when developing particle accelerators based on plasma technology.

In addition to the above-described limitations, it is also of fundamental importance that, in order to reach the high energy values of tens of GeV necessary for particle physics experiments, such plasma sources have longitudinal dimensions ranging between 0.5 and 2 m. The technique employed for fabricating plasma sources characterized by longitudinal dimensions of metres is, therefore, a decisive factor.

### Description of the Prior Art

The particle accelerators currently known in the art, both conventional and plasma-based, must ensure the generation of beams at specific energy levels and high repetition rates (on the order of hundreds of Hz) for periods of time sufficient to allow the execution of an experiment of, for example, particle physics, material science, and interaction with optical radiation.

The average duration of such experiments is approx. 15-20 days, during which the particle accelerator remains in operation 24 hours a day. Such operation and duration conditions are particularly stringent when accelerators are used for producing beams meeting specific constraints and/or requirements within experiments in the fields of particle physics, material science, and study of interactions with optical radiation, e.g. as required by the EuPRAXIA@SPARC_LAB project.

The EuPRAXIA project is a European project dedicated to developing an accelerator based on plasma technology. The main goal of this project is to reach accelerating gradients on the order of tens of GV/m, which cannot be attained at present with conventional techniques based on the use of radio-frequency pulses.

To this day, conventional accelerators ensure that such operating conditions can be obtained (i.e. repetition rates of hundreds of Hz). On the other hand, this still has to be demonstrated for plasma accelerators. In this regard, that element of a plasma accelerator which is most subject to degradation is the plasma source itself, because of the very reasons explained above, i.e. high temperatures and high repetition rates.

In such operating conditions, a plasma source operating at 100 Hz will have to be able to preserve its properties for more than 108 consecutive discharges without showing any alteration in its physical characteristics.

Compared with conventional radio-frequency (RF) accelerators capable of reaching hundreds of Hz, plasma accelerators are deemed to be the possible accelerators of the future because they can provide energy gradients which are thousands of times higher than those provided by RF accelerators. It has also been demonstrated that such high energy values can be produced up to a rate of 1 Hz to 10 Hz.

For future use, therefore, plasma accelerators need to be so constructed as to be able to meet the requirement of stable operation at rates of at least 1 kHz.

In the current state of the art, it is known to use materials such as sapphire, quartz, glass, or other similar materials for making plasma sources for particle acceleration. However, the use of such materials, which are characterized by poor machinability and high costs, is strongly limiting the development of plasma sources for the above-described application.

Furthermore, the thermal conductivity and melting temperature properties required for withstanding temperatures ranging between 1,500° C. and 2,000° C., which can be reached on the walls of the plasma source during the plasma formation process, are not yet suitable for reaching repetition rates on the order of several kHz necessary for future applications in the field of plasma acceleration. Some examples of such future applications of accelerators concern particle physics and the industrial and medical fields.

The currently used plasma sources based on ionization by electric discharge have a maximum length of 40 cm. Such sources are made of 3D-printed plastic materials or stronger materials, like sapphire or quartz. The neutral-gas injection system is made up of vertical injectors directly connected to the tank.

In this context, the study of new materials which can be used as plasma sources represents the basis of the plasma source according to the present invention.

### SUMMARY OF THE INVENTION

It is therefore one object of the present invention to propose a plasma source for particle acceleration which can reach repetition rates on the order of one kHz to solve the problems highlighted above.

In particular, the present invention overcomes those criticalities which derive from the necessity of using materials capable of withstanding temperatures on the order of several tens of thousands of Celsius degrees, which are reached during the electric-arc formation process, by envisaging the use of ceramic materials characterized by high thermal conductivity and high melting temperature.

Said ceramic materials can also be machined easily, thus allowing the parts that make up the plasma source according to the present invention to be manufactured either as one piece or as modular elements.

Moreover, the present invention addresses those problems which derive from the necessity of reaching high energy values as required by particular particle physics experiments, by providing a method of making a plasma source characterized by a longitudinal channel size on the order of a few metres, which is necessary to reach specific energy values.

This is made possible by said method of making according to the present invention, which includes a step of modular production of the components of the plasma source.

By implementing, thanks to such method of making, linear accelerators having wavelengths on the order of tens of metres, it is possible to reach the high energy values required by the experiments, which otherwise could only be obtained by means of kilometres of conventional structures (accelerating gradients on the order of GV/m as opposed to MV/m).

Along with the high machinability of the ceramic materials identified as most suitable due to their physical properties, said method allows producing plasma sources comprising longitudinal structures that may reach lengths on the order of metres, thanks to the possibility of assembling together multiple sections by using the technique hereafter described.

Plasma sources made by using said process and said ceramic materials characterized by high thermal conductivity can dissipate the heat produced on the surfaces of said longitudinal structures in contact with the plasma.

The present invention concerns a plasma source for high-repetition-rate accelerators which can overcome the drawbacks of the prior art, and which permits the achievement of accelerating gradients on the order of tens of GV/m while operating constantly at repetition rates in excess of 100 Hz, more preferably at a repetition rate of 400 Hz.

It is another object of the present invention to provide a plasma source for high-repetition-rate accelerators which is made of ceramic materials capable of withstanding high thermal stresses, thus ensuring a lifetime corresponding to tens of millions of discharges before the properties of said plasma source start to degrade.

It is a further object of the present invention to provide a method of making a plasma source for high-repetition-rate accelerators having metre-scale dimensions to permit the achievement of energy values on the order of tens of gigaelectronvolts (GeV) as necessary for particle physics applications.

### BRIEF DESCRIPTION OF THE DRAWINGS

Further objects and advantages of the present invention will become apparent in light of the following detailed description of an exemplary embodiment (and variants thereof) referring to the annexed drawings, which are merely supplied by way of non-limiting example, wherein:

FIG. 1a shows a confinement structure of a plasma source for high-repetition-rate accelerators according to the present invention;

FIG. 1b is a magnified view of a single section of the confinement structure of FIG. 1;

FIG. 2a shows a support structure of a plasma source for high-repetition-rate accelerators according to the present invention;

FIG. 2b is a side view of the support structure of FIG. 2a;

FIG. 3a shows a fully assembled plasma source for high-repetition-rate accelerators according to the present invention;

FIG. 3b is a sectional view of the assembled plasma source according to the present invention;

FIGS. 4a and 4b are, respectively, a front view and a top view of a first device used during a step of assembling the confinement structure of the present invention;

FIGS. 5a and 5b are, respectively, a front view and a top view of a second device used during a step of assembling the confinement structure of the present invention.

In the drawings, the same reference numerals and letters identify the same items or components.

### DETAILED DESCRIPTION OF SOME EMBODIMENTS

The invention aims at creating a plasma source for high-repetition-rate accelerators.

A plasma source 10 is a structure known in the art, hereafter referred to as confinement structure 20, wherein, essentially, a gas is confined under pressures ranging between 10 and 100 mbar and injected into a plasma formation channel 21 by means of a gas distribution system. The gas distribution system comprises a plurality of injectors 23 and a gas distribution service channel, hereafter referred to as service channel 22, fluidically connected to each other. Gas injection is followed by an ionization, or plasma creation, phase, which is carried out by applying a potential difference (high voltage, HV) across the ends of the plasma formation channel 21 by means of a pair of electrodes 31 disposed laterally relative to a longitudinal axis of the plasma source 10 and in fluidic communication with the plasma formation channel 21.

For this purpose, an electric discharge is used which has a voltage value ranging between 5 and 20 kV, with current values ranging between 100 and 2,000 A. In order to obtain the desired plasma density and the desired longitudinal distribution, it is possible to adjust the synchronism between the gas injection phase and the application of HV for gas ionization, since also the applied potential difference contributes to optimizing the plasma formation process. The plasma source 10 is a structure capable of interacting with the particle beams created by a photoinjector according to conventional RF-based techniques. When the plasma source 10 is installed in a particle accelerator, once plasma has been created as described above, particle beams can be injected which are to be accelerated through said plasma.

The size, geometry and position of the elements that make up the confinement structure 20 of the plasma source 10 are key factors of the plasma formation process, and hence affect the efficiency of the interaction with the particle beams to be accelerated.

For latest-generation plasma-based accelerators, the longitudinal dimensions should be at least several tens of centimetres, up to several metres. Such dimensions are necessary to reach energy values on the order of hundreds of gigaelectronvolts (GeV), which are key values for future applications like optical radiation production in Free Electron Lasers (FEL) and particle physics experiments. Moreover, a plasma accelerator provides a drastic reduction in dimensions and costs compared with a conventional one based on the use of radio-frequency accelerating sections. For this reason, it is of the utmost importance that materials have physical properties that make them particularly suitable for dissipating the thermal energy produced during the plasma formation phase. Heat dissipation capacity is fundamental to allow for operating conditions at repetition rates on the order of one kHz. The requirements related to such a complex geometry and to said use of sufficiently heat-resistant, but also easily machinable, materials lie at the basis of the present invention.

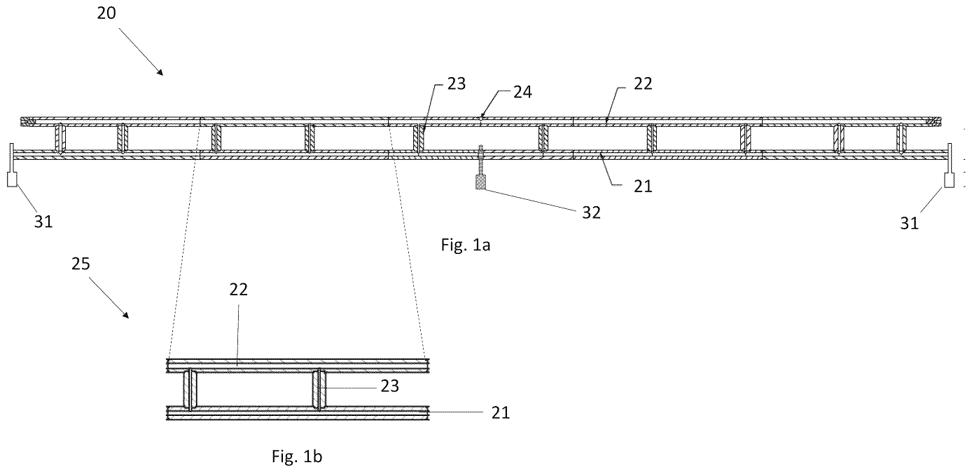

FIG. 1a shows a plasma-confining structure 20 for a plasma source 10 for high-repetition-rate accelerators according to the present invention.

As aforementioned, the plasma-confining structure 20 is a tubular structure developing in a longitudinal direction, and comprises a plasma formation channel 21, a service channel 22, substantially parallel to said plasma formation channel 21, and a plurality of injectors 23 adapted to provide a fluidic connection between said plasma formation channel 21 and said service channel 22, so that the gas can flow from the service channel 22 towards the plasma formation channel 21 during the plasma formation process, as previously described.

FIG. 1b shows in more detail a module 25 of the plasma-confining structure 20 of FIG. 1. As will be further described below in the section of this document which will describe the method of making said plasma source 10, the plasma-confining structure 20 is made by coupling together, e.g. through interlocking joints, a plurality of said modules 25. Each one of the modules 25 comprises a first segment of the plasma formation channel 21, a second segment of the service channel 22, and at least one injector 23 adapted to provide the fluidic connection between the segment of the plasma formation channel 21 and the segment of the service channel 22.

According to one embodiment of the present invention, in order to overcome the previously highlighted drawbacks, the plasma formation channel 21 preferably has a diameter ranging between 0.5 mm and 2.5 mm, more preferably ranging between 1 mm and 2 mm, depending on the plasma density required by the different applications. Furthermore, said plasma formation channel 21, and therefore the entire structure of the plasma source 10, has a minimum length of several tens of centimetres, preferably at least 60 cm.

According to a preferred embodiment, the plasma formation channel 21 has a diameter of 1 mm, while the service channel has a diameter ranging between 1 mm and 2 mm.

Based on the above-defined channel diameters, each module 25 may have a length of 10 cm to 15 cm.

The number of injectors 23 connecting the service channel 22 and the plasma channel 21 is also dependent on the overall length of the plasma source 10 and on specific requirements as to the distribution of electrons in the plasma (the so-called longitudinal plasma profile).

The plurality of injectors 23 have a diameter ranging between 1 mm and 2 mm to ensure proper control over the longitudinal uniformity of the electronic plasma distribution. In order to use a plasma source 10 in acceleration experiments, i.e. in order to obtain a correct interaction between beam electrons and plasma, some specifications need to be complied with as regards the distribution of electrons in the plasma. Such specifications concern the degree of uniformity with which such electrons are distributed throughout the length of the plasma-confining structure 20.

By way of example, in order to manufacture a plasma source 10 having a length of 60 cm, four modules 25 having a length of 15 cm or six modules having a length of 10 cm will have to be used.

The modular solution adopted herein for creating a plasma-confining structure 20 by coupling a plurality of modules 25 together makes it possible to obtain a specific length suitable for use in a particular application. As an example, said modules may be coupled together by means of interlocking joints. Furthermore, this modular solution overcomes the technical problems that prevent obtaining, within hard and difficult-to-machine materials like those used for manufacturing this type of devices, channels 21, 22 of the plasma-confining structure 20 with inner cavities having a diameter of 1 mm to 2 mm for lengths of the plasma source 10 ranging from a few tens of centimetres up to a few metres.

Based on material research and prototype tests, a first ceramic material, known as Shapal, has been identified as suitable for making the plasma-confining structure 20. Shapal is characterized by favourable physical properties, including a high thermal conductivity value k of 92 W/(mK) and a melting temperature of 2,300° C. Such properties make Shapal highly suitable for construction of the plasma-confining structure 20, since it is sufficiently strong to withstand the thermal stresses undergone during the generation of the high-voltage discharges that are necessary to create plasma, while also being able to dissipate the heat produced by direct surface contact with plasma.

It must be pointed out that the values of such properties are significantly higher than those of the materials known in the art and currently in use. For example, sapphire has a thermal conductivity value of approx. 40 W/(mK), while glass and quartz have much lower values of 1-2 W/mK.

FIG. 1a also shows the pair of electrodes 31 arranged laterally relative to a longitudinal axis of the plasma-confining structure 20, in particular in fluidic communication with the plasma formation channel 21, and used for generating electric discharges during the above-described plasma generation process.

FIG. 1a also shows a ground electrode 32. The ground electrode 32 and the pair of electrodes 31 are configured to allow the production of high-voltage electric discharges on the order of tens of kilovolts, with currents of hundreds of Amperes, during a plasma formation process. The electrode 32 can be regarded as an auxiliary electrode for splitting the application of the potential difference into two parts.

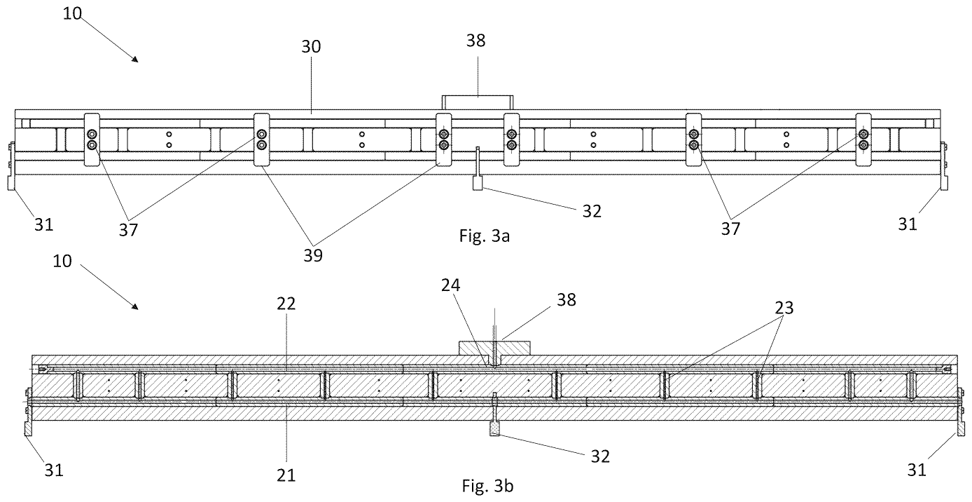

Lastly, FIG. 1a also shows an opening 24 in the service channel 22, configured to allow plugging in a gas distribution system 38, shown in FIGS. 3a and 3b.

The plasma source 10 according to the present invention further comprises a structure adapted to provide optimal structural support for the plasma-confining structure 20.

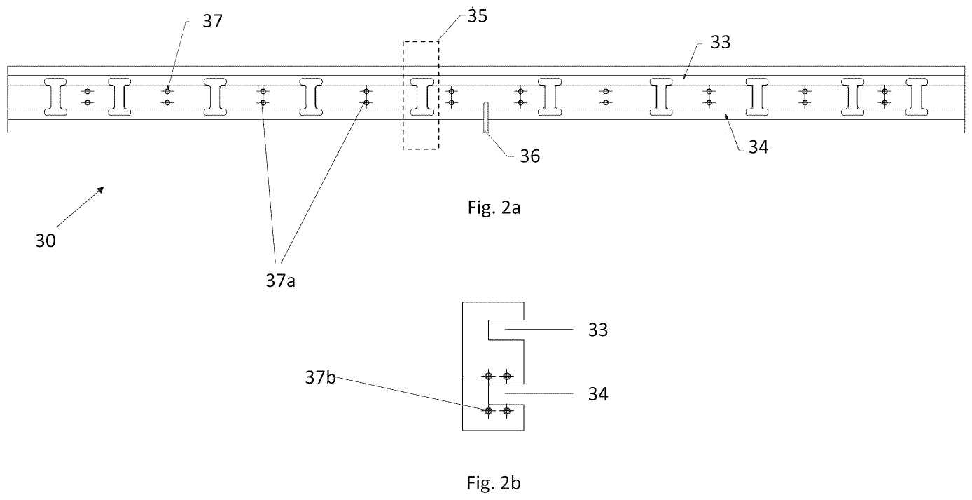

FIG. 2a shows said support structure 30, which, just like the plasma-confining structure 20, develops along a longitudinal direction, and which and has a length at least equal to the length of the plasma-confining structure 20. The support structure 30 is, in fact, configured to internally house the plasma-confining structure 20 once the latter has been assembled. As clearly depicted in FIG. 2b, which shows a side view of the support structure 30, there are a first groove 33, adapted to house the service channel 22, and a second groove 34, adapted to house the plasma formation channel 21. The first groove 33 and the second groove 34 develop substantially parallel to the longitudinal development of the plasma formation channel 21 and service channel 22.

The support structure 30 further comprises a plurality of engagement blocks 35 formed inside the support structure 30 and arranged between the first groove 33 and the second groove 34 along a direction perpendicular thereto. The plurality of engagement blocks 35 are configured to house the plurality of injectors 23 that are present on the plasma-confining structure 20.

Based on the elements described thus far, it is apparent that a first function of the support structure 30 is to support and protect the plasma formation channel 21.

The support structure 30 is made of a second ceramic material, known as Macor. Macor is a ceramic material characterized by a high melting temperature, approximately 1,000° C., and by good machinability with machine tools. Thanks to this latter property, the support structure 30 can be manufactured as one piece. The possibility of manufacturing the support structure 30 as one piece results, in turn, in optimized dissipation of the thermal energy produced within the plasma-confining structure 20 during the plasma generation process, in that one-piece construction avoids the need for a plurality of junctions between adjacent portions of the support structure 30, which junctions would otherwise hinder heat dissipation.

In addition to the support function, the support structure 30 also performs a connection function for a plurality of elements external to the plasma source 10 and necessary both for the operation of the plasma source 10 itself and for the production of particle beam acceleration. The function of connecting the plurality of external elements is provided through a first plurality of fastening holes 37a and a second plurality of fastening holes 37b. The first plurality of fastening holes 37a are configured to receive a plurality of fastening elements 39, shown in FIG. 3a, which are used for joining the confinement structure 20 to the support structure 30. The second plurality of fastening holes 37b in said support structure 30 are configured to connect to the plasma source 10 the pair of electrodes 31 in fluidic communication with the plasma formation channel 21 and adapted to produce the electric discharge during the plasma formation process.

Lastly, FIG. 2a shows a cavity 36 configured to house the ground electrode 32.

FIG. 3a shows the plasma source 10 for high-repetition-rate accelerators according to the present invention in a fully assembled condition, wherein one can see the support structure 30 to which the plurality of fastening elements 39 have been applied by coupling them with the plurality of fastening holes 37. The drawing also shows the electrodes 31, 32 used during the plasma generation process. Furthermore, FIG. 3a also shows the connector for plugging in the gas distribution system 38.

FIG. 3b shows a sectional view of the assembled plasma source 10 of FIG. 3a, wherein one can see the arrangement of the plasma-confining structure 20 housed within the support structure 30, as well as the external elements fastened to said plasma-confining structure 20. In particular, such external elements visible in FIG. 3b are the pair of electrodes 31, the ground electrode 32, and the connector for plugging in the gas distribution system 38, coupled with the opening 24 provided on the service channel 22.

The plasma-confining structure 20 and the support structure 22 are made of different ceramic materials because they are subject to different stresses. In particular, the plasma-confining structure 20 is directly in contact with plasma, and is therefore exposed to very high temperatures, ranging between 2 and 10 eV, i.e. up to 100,000° C.

It is for this reason that a highly resistant material, like Shapal, must be used. The properties of Shapal are far superior to those of sapphire, particularly thermal conductivity and melting temperature, which make it more suitable to resist the plasma discharges, while ensuring a source lifetime compliant with future high-repetition-rate plasma acceleration applications as required by the EuPRAXIA project. However, Shapal cannot be easily machined to obtain a one-piece plasma-confining structure 20 which is long enough, i.e. at least 50 cm, to allow reaching high energy values of tens of GeV as necessary for particle physics experiments, while at the same time withstanding repetition rates in excess of 100 Hz when inserted in a latest-generation accelerator. It is for this reason that, as will be further described below, the method of making a plasma source 10 according to the present invention uses a modular approach to the problem, since it must necessarily balance the requirements concerning the properties of a material suitable for using plasma in high-repetition-rate accelerators, i.e. Shapal, with the necessity of obtaining long structures from Shapal, which does not have good machinability properties.

Differently from the plasma-confining structure 20, the material of the support structure 30 has to withstand temperatures lower than those to which Shapal is subjected, but must have good machinability. The reason for this is that, on the one hand, the support structure 30 must be used as a seat for a plurality of fastening elements for external components, e.g. the electrodes 31, 32, and, on the other hand, said support structure 30 must be made as one piece because the presence of any junctions would hinder the dissipation of the thermal energy produced on the surfaces of the plasma formation channel 21 in contact with the support structure 30 during the plasma production process.

This second ceramic material is Macor. The properties of Macor have turned out to be suitable for the above-described purposes. Macor is easily available in large sizes for making support structures 30 that may be as long as a few metres. Moreover, since it is less expensive than Shapal, which is not easily available in sizes large enough to allow manufacturing the entire plasma source 10, it contributes to lowering the overall costs incurred for producing the plasma source 10 according to the present invention.

The plasma source 10 according to the present invention is manufactured by means of a process that finds in modularity a balance between a first necessity of using a poorly machinable material and a second necessity of being able to create structures with complex geometries having a length ranging between a few tens of centimetres and a few metres, preferably between 0.5 and 2 m, or even more.

Furthermore, given the articulated structure of the plasma source 10 and the need for said structure to ensure a correct alignment among the plurality of its parts, some special devices have been designed to aid the assembling phase. During the assembling phase, particular attention needs to be paid to the plasma formation channel 21, because this is a structure that develops longitudinally to a total length as indicated above, with a precision on the order of a hundred micron, and with no discontinuity between the modules 25, to allow the passage of beams of particles having diameters on the order of tens of microns.

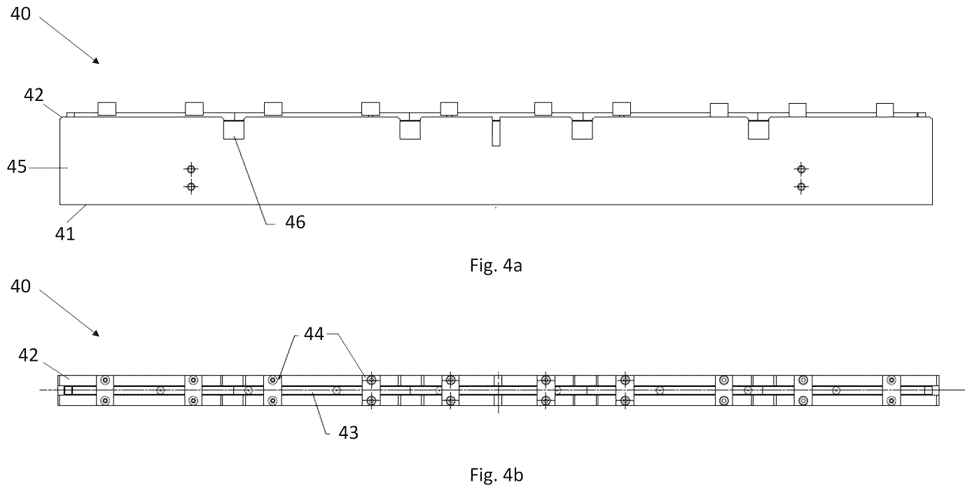

FIGS. 4a and 4b show, respectively, a front view and a top vies of a first device 40 used during a first step of assembling the plasma-confining structure 20 according to the present invention. The first device 40, which has a parallelepiped shape, comprises, on a top base surface 42 opposite a bottom base surface 41, a groove 43 extending in a longitudinal direction throughout the length of the first device 40 and shaped to house both a first plurality of Shapal segments adapted to form the plasma formation channel 21 and a second plurality of Shapal segments adapted to form the service channel 22 during the respective assembling steps. On the top base surface 42 fastening means 44 are disposed, which are used in phase for assembling the plasma formation channel 21 and the service channel 22, preferably in order to delimit the space above the segments when they are inserted into the groove, so as to maintain a straight direction.

Lastly, the first device 40 has on a lateral surface 45 thereof which is perpendicular to the top base surface 42, a plurality of grooves 46 at the point of contact between said lateral surface 45 and said top base surface 42, so disposed as to coincide with the junction zones of two adjacent segments. The plurality of grooves 46 are used during gluing operations.

In a first step, a plurality of Shapal segments are assembled together to create the plasma formation channel 21 and the service channel 22. The number of segments for both channels 21,22 is determined by the total length that the plasma source 10 must reach to achieve the goal of obtaining energy values necessary for the execution of an experiment in a specific field of application. The Shapal segments of a first plurality are inserted into the groove 43 one after the other, so as to establish a mutual coupling between pairs of segments, e.g. by interlocking. Subsequently, when the desired length of the plasma formation channel 21 has been reached, a gluing operation is carried out by applying a special ultra-high-vacuum glue. Said glue is used in order to insulate the junction zones between one segment and the next, thus preventing any gas leakage from non-predetermined areas of the plasma source 10 that might produce, inside an accelerator, undesired electric discharges around the plasma source 10. The fastening means 44 are useful to hold in position the first plurality of Shapal segments and facilitate the gluing operation. The glue is applied by pouring it onto the outer surfaces of the segments near the junctions between adjacent segments. Any excess glue is removed to avoid the formation of rough spots that might affect the proper housing of the plasma confining structure 20 within the support structure 30.

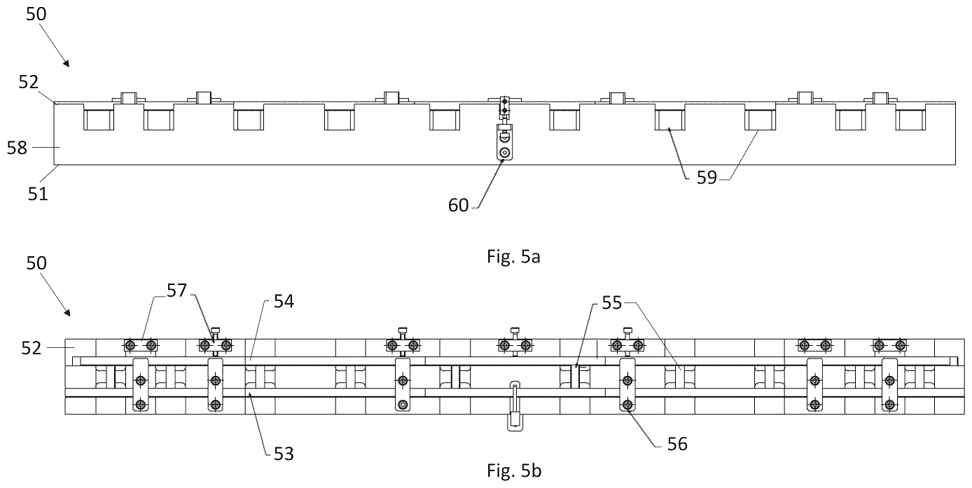

As described above with reference to the operations of assembling and gluing the segments constituting the plasma formation channel 21, the same operations are replicated with a second plurality of Shapal segments in order to create the service channel 22. Once the plasma formation channel 21 and the service channel 22 have been obtained, a second device 50, shown in FIGS. 5a and 5b, is used during a second phase of assembling the plasma-confining structure 20 according to the present invention. The second device 50, which is parallelepiped in shape, comprises, on a top base surface 52 opposite a bottom base surface 51, a first groove 53 and a second groove 54 extending parallel to each other in a longitudinal direction throughout the length of the second device 50. The grooves 53,54 are shaped for housing the plasma formation channel 21 and the service channel 22, respectively, as pre-assembled in the previous step. On the same top base surface 52 there are also, in the area between the first groove 53 and the second groove 54, a plurality of third grooves 55 oriented in a direction perpendicular to said first groove 53 and second groove 54. The plurality of third grooves 55 are adapted to receive a third plurality of Shapal segments for creating the plurality of injectors 23. The top base surface 52 further comprises a first plurality of fastening means 56 and a second plurality of fastening means 57.

In addition, the second device 50 has on a lateral surface 58 thereof which is perpendicular to the top base surface 52, a plurality of grooves 59 at the points of contact between said lateral surface 58 and said top base surface 52, so disposed as to coincide with the junction zones between the plurality of injectors 23 and the plasma formation channels 21 and the service channel 22. Lastly, the second device 50 has on the same lateral surface 58, positioning means 60 for a ground electrode 32.

In a second step, the plasma formation channel 21 and the service channel 22 are assembled together with the plurality of injectors 23. In particular, the first plasma formation channel 21 is arranged inside the first groove 53, and then the third plurality of Shapal segments are arranged inside the plurality of third grooves 55 to form the plurality of injectors 23. Finally, the service channel 22 is arranged inside the second groove 54. The first plurality of fastening means 56 and the second plurality of fastening means 57 are so adjusted as to obtain a coupling between the plurality of injectors 23 and the plasma formation channel 21 and said service channel 22 that establishes a fluidic connection between the plasma formation channel 21 and the service channel 22 through the plurality of injectors 23. Furthermore, the first plurality of fastening means 56 and the second plurality of fastening means 57 make it possible to keep the plasma formation channel 21 and the service channel 22 properly aligned and parallel to each other.

Afterwards, a gluing operation is carried out by pouring special ultra-high-vacuum glue onto first junction zones between a first end of the plurality of injectors 23 and the plasma formation channel 21 and onto second junction zones between a second end of the plurality of injectors 23 and the service channel 22. The plurality of grooves 59 are used during the gluing operations. The glue is applied by pouring it onto the outer surfaces of the segments near the junctions between adjacent segments. Any excess glue is removed to avoid the formation of rough spots that might affect the proper housing of the plasma-confining structure 20 within the support structure 30.

In a third connection step, the plasma source 10 obtained from the previous assembling steps is housed within the support structure 30, which is made as one piece of Macor. Then the plurality of fastening elements 39 are applied to the support structure 30 through the plurality of fastening holes 37, so as to ensure the proper positioning and alignment of the plasma source 10. Finally, the ground electrode 32 and the pair of electrodes 31, mounted laterally relative to a longitudinal axis of the plasma-confining structure 20, are connected.

When used in high-repetition-rate accelerators, the plasma source 10 according to the present invention makes it possible to reach accelerating gradients on the order of tens of GV/m, with stable operation at repetition rates in excess of 100 Hz, more preferably up to a repetition rate of 400 Hz.

Furthermore, the plasma source 10 according to the present invention can, being particularly resistant to thermal stresses, guarantee a lifetime corresponding to tens of millions of discharges before the properties of said plasma source start to degrade.

Lastly, the modular architecture adopted in the construction of the plasma source 10 according to the present invention makes it possible to create plasma sources 10 having metre-scale lengths, thus allowing the achievement of energy values of tens of Gigaelectronvolts (with source lengths up to 2 m and accelerating gradients of tens of GV/m) as required by the first applications of the EuPRAXIA project, which concern experiments involving the production of FEL radiation by means of plasma-accelerated electron beams.

Anyway, due to the modularity of this technique, plasma sources based on such construction technique may, in the future, reach lengths of tens of metres to produce beams having energy values on the order of one teraelectronvolt (TeV).

The above-described example of embodiment may be subject to variations without departing from the protection scope of the present invention, including all equivalent designs known to a person skilled in the art.

The elements and features shown in the various preferred embodiments may be combined together without however departing from the protection scope of the present invention.

In light of the above description, those skilled in the art will be able to produce the subject of the invention without introducing any further construction details.

1. A plasma source for high-repetition-rate accelerators, said plasma source comprising:
a plasma-confining structure made of a first ceramic material and configured to develop along a longitudinal direction according to a tubular geometry, comprising a plasma formation channel, a service channel substantially parallel to said plasma formation channel, a plurality of injectors adapted to provide a fluidic connection between said plasma formation channel and said service channel
a support structure made of a second ceramic material and configured to house said plasma-confining structure

2. The plasma source according to claim 1, wherein said plasma source has a length ranging between 0.5 m and 2 m.

3. The plasma source according to claim 1, wherein said first ceramic material used for making said plasma-confining structure is Shapal.

4. The plasma source according to claim 1, wherein said second ceramic material used for making said support structure is Macor.

5. The plasma source according to claim 1, wherein said plasma-confining structure is a modular structure comprising a plurality of modules, wherein each module of said plurality of modules comprises a first segment of said plasma formation channel, a second segment of said service channel and at least one injector adapted to provide said fluidic connection between said first segment of the plasma formation channel and said second segment of the service channel.

6. The plasma source according to claim 5, wherein each module of said plurality of modules has a length ranging between 10 cm and 15 cm.

7. The plasma source according to claim 1, wherein said plasma formation channel has a diameter ranging between 0.5 mm and 2.5 mm.

8. The plasma source according to claim 1, wherein said service channel has a diameter ranging between 1 mm and 2 mm.

9. The plasma source according to claim 1, wherein said plurality of injectors has a diameter ranging between 1 mm and 2 mm.

10. The plasma source according to claim 1, wherein said service channel comprises an opening configured to allow plugging in a gas distribution system

11. The plasma source according to claim 1, wherein said support structure configured to house said plasma-confining structure is made as one piece and comprises a first groove and a second groove wherein said first groove and said second groove develop along a longitudinal direction substantially parallel to each other.

12. The plasma source according to claim 11, wherein said support structure further comprises a plurality of engagement blocks arranged between said first groove and said second groove along a direction perpendicular to said first groove and said second groove.

13. The plasma source according to claim 1, wherein said support structure further comprises a cavity configured to house a ground electrode

14. The plasma source according to claim 1, wherein said support structure further comprises a plurality of fastening elements adapted to connect said confinement structure to said support structure through a first plurality of fastening holes.

15. The plasma source according to claim 1, wherein said support structure further comprises a second plurality of fastening holes adapted to connect a pair of electrodes arranged laterally relative to an axis of longitudinal development of said plasma source, said pair of electrodes being in fluidic communication with said plasma formation channel.

16. A particle accelerator comprising a plasma source according to cliam 1.

17. The particle accelerator according to claim 16, wherein said plasma source is adapted for use in a plasma formation process executed at a repetition rate ranging between 100 Hz and 400 Hz and at temperatures ranging between 1,500° C. and 2,000 °C.

18. The particle accelerator according to claim 17, wherein a lifetime of said plasma source is at least equal to 108 consecutive discharges generated at a repetition rate of 100 Hz during a plasma formation process.

19. A method of making a plasma source according to claim 1, said method comprising the steps of:
assembling, by mutual coupling, a first plurality of segments made of a first ceramic material together with a second plurality of segments made of said first ceramic material, which are adapted to constitute, respectively, the plasma formation channel and the service channel having the same length, wherein said length determines a total length of said plasma source
assembling, by mutual coupling, the plasma formation channel and the service channel together with a plurality of injectors made of said first ceramic material, wherein each injector belonging to the plurality of injectors is so arranged as to provide a fluidic connection between said plasma formation channel and said service channel to form the plasma-confining structure;
connecting the plasma-confining structure to the support structure said support structure being made as one piece of a second ceramic material.

20. The method according to claim 19, wherein the step of connecting is carried out by means of a plurality of fastening elements disposed into a first plurality of fastening holes formed in said support structure.

21. The method according to claim 19, wherein the steps of assembling comprise a gluing operation wherein a special ultra-high-vacuum glue is applied in order to insulate junction zones formed by the coupling between: segments of the first plurality of segments constituting the plasma formation channel, segments of the second plurality of segments constituting the service channel, the plurality of injectors and the plasma formation channel, the plurality of injectors and the service channel.

22. The method according to claim 19, wherein the first plurality of segments, the second plurality of segments and the plurality of injectors are made of Shapal.

23. The method according to claim 19, wherein the second ceramic material used for making said support structure is Macor.
